(19) United States
(12) Patent Application Publication
(10) Pub. No.: US 2026/0360845 A1
(43) Pub. Date: Nov. 12, 2026

(54) METHOD FOR MANUFACTURING SECONDARY BATTERY

(71) Applicant: TOYOTA JIDOSHA KABUSHIKI KAISHA, Toyota-shi (JP)

(72) Inventors: Takuto NISHIKAWA, Toyota-shi (JP); Hajime HASEGAWA, Aichi-ken (JP); Mitsuru TATEISHI, Toyota-shi (JP); Shun TAKEOKA, Toyota-shi (JP); Shinya TAKESHITA, Toyota-shi (JP); Chihiro MATSUDA, Toyohashi-shi (JP); Keiichiro KANMI, Toyota-shi (JP); Tomoyuki KAWAI, Kariya-shi (JP); Yuta KAWAMOTO, Kariya-shi (JP)

(73) Assignee: TOYOTA JIDOSHA KABUSHIKI KAISHA, Toyota-shi (JP)

(21) Appl. No.: 19/577,665

(22) Filed: Mar. 25, 2026

(30) Foreign Application Priority Data
May 9, 2025 (JP) 2025-078545

(51) Int. Cl. H01M 10/44

(52) U.S. Cl. CPC H01M 10/446

(57) ABSTRACT

The method for manufacturing a secondary battery includes: injecting an electrolyte; performing initial charging; raising the temperature of a stack; performing CCCV charging on odd-numbered cells; performing CCCV charging on even-numbered cells; performing CC charging on the odd-numbered cells; performing CC charging on the even-numbered cells; cooling the stack after the CC charging of the odd-numbered cells and the CC charging of the even-numbered cells have been alternately repeated n times; performing a self-discharge test.

### CROSS-REFERENCE TO RELATED APPLICATION

This application claims priority to Japanese Patent Application No. 2025-078545 filed on May. 9, 2025. The disclosure of the above-identified application, including the specification, drawings, and claims, is incorporated by reference herein in its entirety.

### BACKGROUND

### 1. TECHNICAL FIELD

The present disclosure relates to methods for manufacturing a secondary battery.

### 2. DESCRIPTION OF RELATED ART

Japanese Unexamined Patent Application Publication No. 2019-021513 (JP 2019-021513 A) discloses a secondary battery including one or more cells each including an electrode stack in which a plurality of bipolar electrodes is stacked with separators interposed therebetween.

### SUMMARY

A method for manufacturing a bipolar secondary battery in which bipolar electrodes and separators of the type described above are stacked to form multiple cells includes a high-temperature aging step for purposes such as dissolving foreign matter and forming coatings. This high-temperature aging step includes a step of charging all cells to a specified voltage.

However, when the group of cells arranged in even-numbered positions and the group of cells arranged in odd-numbered positions are charged separately in the step of charging all cells to the specified voltage, the charging timing differs between these two groups. As a result, the slope of the voltage change during post-charging determination as to whether the cells are acceptable or defective differs between the group of odd-numbered cell and the group of even-numbered cells. It is therefore desired to further improve the accuracy of the determination as to whether the cells are acceptable or defective.

The present disclosure has been made to address the above issue. An object of the present disclosure is to provide a method for manufacturing a secondary battery that improves the accuracy of determination as to whether cells are acceptable or defective.

A method for manufacturing a secondary battery according to one aspect of the present disclosure is a method for manufacturing a secondary battery including a plurality of cells each including a bipolar electrode and a separator. The cells include a group of odd-numbered cells arranged at odd-numbered positions from one end, and a group of even-numbered cells arranged at even-numbered positions from the one end. The method includes: performing constant-voltage charging while alternately switching a charging target between the group of odd-numbered cells and the group of even-numbered cells before determining whether the cells are acceptable or defective; and after the constant-voltage charging, alternately repeating constant-current charging of the group of odd-numbered cells and constant-current charging of the group of even-numbered cells a plurality of times.

In this manner, by alternately repeating constant-current charging on the group of odd-numbered cells and the group of even-numbered cells a plurality of times after completion of the constant-voltage charging, the voltages of both cell groups can be made equal. As a result, determination as to whether the cells are acceptable or defective can be performed at a high voltage for both the group of odd-numbered cells and the group of even-numbered cells. Therefore, it is possible to improve the accuracy of determination as to whether the cells are acceptable or defective while also reducing the lead time for the determination.

In the embodiment, the method further includes repeatedly performing the constant-current charging a number of times such that the difference between a voltage of one of the group of odd-numbered cells and the group of even-numbered cells after the constant-current charging and a voltage of the other of the group of odd-numbered cells and the group of even-numbered cells before the constant-current charging is less than or equal to a threshold.

In this manner, by repeatedly performing the constant-current charging a number of times such that the difference between the voltage of one of the group of odd-numbered cells and the group of even-numbered cells after the constant-current charging and the voltage of the other group before the constant-current charging becomes less than or equal to the threshold, the voltages of the group of odd-numbered cells and the group of even-numbered cells can be made equal before determination as to whether the cells are acceptable or defective is performed. Therefore, the accuracy of determination as to whether the cells are acceptable or defective can be improved.

In the embodiment, the method further includes alternately repeating the constant-current charging of the group of odd-numbered cells and the constant-current charging of the group of even-numbered cells a plurality of times until a predetermined time has elapsed since completion of the constant-voltage charging.

In this manner, by alternately repeating constant-current charging on the group of odd-numbered cells and the group of even-numbered cells a plurality of times until the predetermined time has elapsed, the voltages of the group of odd-numbered cells and the group of even-numbered cells can be made equal before determination of whether the cells are acceptable or defective is performed. Therefore, the accuracy of determination as to whether the cells are acceptable or defective can be improved.

The present disclosure provides a method for manufacturing a secondary battery that improves the accuracy of determination as to whether cells are acceptable or defective.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart showing the steps of a method for manufacturing a secondary battery according to an embodiment of the present disclosure;

FIG. 2 is a sectional view of a stack that constitutes a secondary battery according to the embodiment;

FIG. 3 is a diagram illustrating charging of each cell and a self-discharge test performed after charging;

FIG. 4 is a flowchart showing an example of a method for manufacturing a secondary battery according to a comparative example;

FIG. 5 is a diagram showing an example of voltage changes of odd-numbered cells and even-numbered cells in the comparative example; and

FIG. 6 is a diagram showing an example of voltage changes of odd-numbered cells and even-numbered cells in the embodiment.

### DETAILED DESCRIPTION OF EMBODIMENTS

Hereinafter, an embodiment of the present disclosure will be described in detail with reference to the drawings. The same or corresponding portions are denoted by the same signs throughout the drawings, and description thereof will not be repeated. In the drawings used in the following description, the X-axis, Y-axis, and Z-axis are perpendicular to each other, and the Z-axis direction represents the thickness direction of the battery. Hereinafter, the directions indicated by the arrows of the X-axis, Y-axis, and Z-axes are denoted with "+," and the opposite directions are denoted with "−."

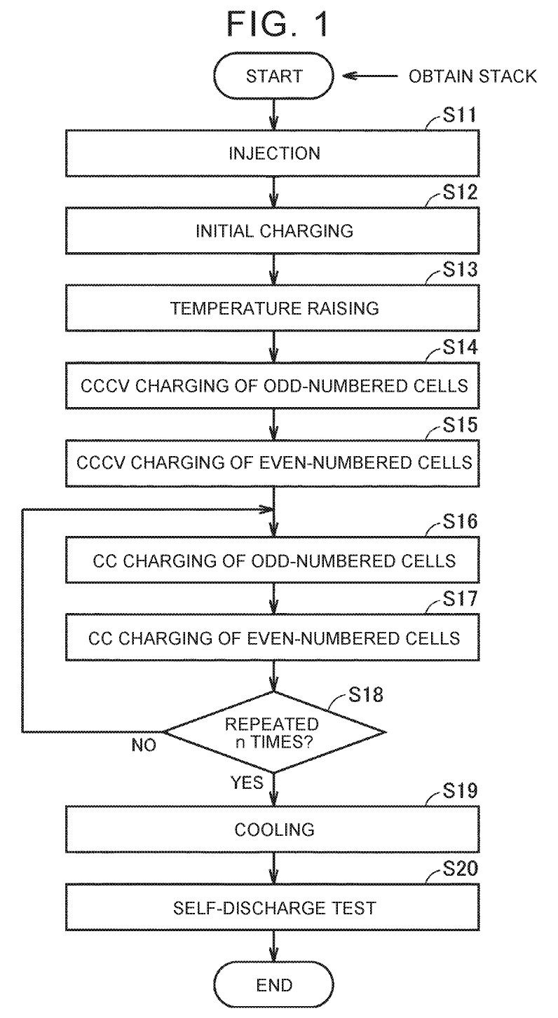

FIG. 1 is a flowchart showing the steps of a method for manufacturing a secondary battery according to an embodiment of the present disclosure. In the method for manufacturing a secondary battery according to the present embodiment, a stack is first formed. Then, according to the process flow shown in FIG. 1, electrolyte injection, charging, aging, and a self-discharge test are performed on the stack. The process flow shown in FIG. 1 will be described in detail later.

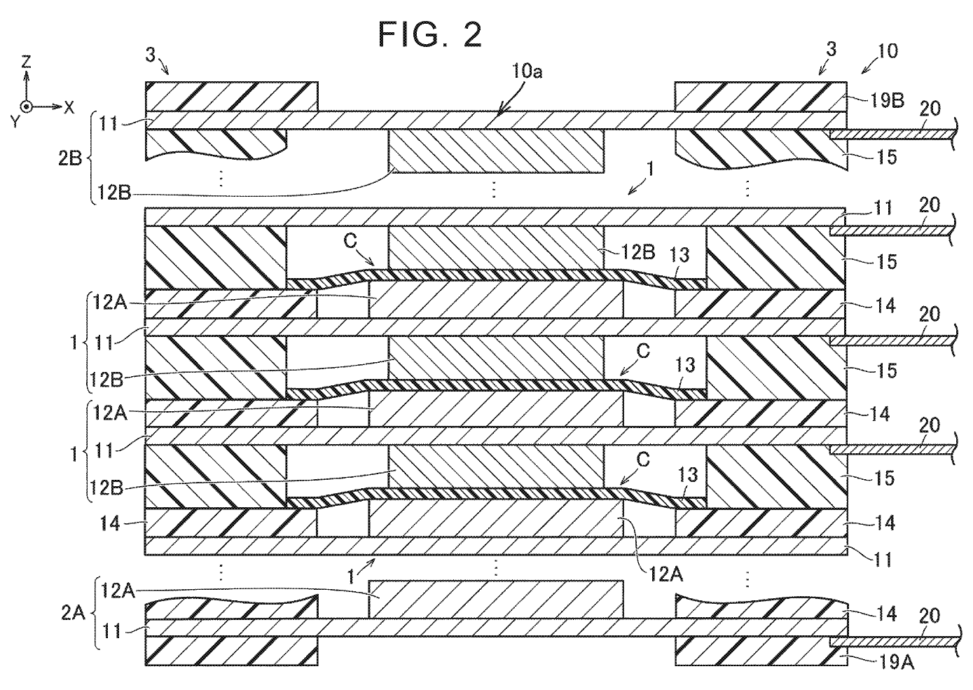

In the present embodiment, a stack 10 shown in FIG. 2 is prepared. FIG. 2 is a sectional view of the stack 10 that constitutes the secondary battery according to the present embodiment. Referring to FIG. 2, the stack 10 includes an energy storage portion 10a and a sealing portion 3 that seals the energy storage portion 10a. The Z-direction corresponds to the stacking direction. The energy storage portion 10a includes a plurality of cells C arranged in the Z-direction. Each of the cells C includes an anode active material layer 12A, a cathode active material layer 12B, and a separator 13. Each of the cells C is configured to store energy. Each of the cells C functions as a secondary battery. Each of the cells C corresponds to an example of the "cell" according to the present disclosure. In the present embodiment, the energy storage portion 10a includes 10 or more cells C. However, the number of cells C can be set as desired. The number of cells C included in the energy storage portion 10a may be three or more and less than 50, or may be 50 or more. The sealing portion 3 is formed to surround the energy storage portion 10a.

The stack 10 includes a plurality of electrodes stacked in the Z-direction (one anode terminal electrode 2A, a plurality of bipolar electrodes 1, and one cathode terminal electrode 2B). Separators 13 are disposed between electrodes. Each bipolar electrode 1 includes a current collector 11, an anode active material layer 12A provided on the +Z-side surface of the current collector 11, and a cathode active material layer 12B provided on the −Z-side surface of the current collector 11. The anode terminal electrode 2A has a configuration obtained by removing the cathode active material layer 12B from the bipolar electrode 1. An insulating layer 19A covering the peripheral edge of the current collector 11 is formed on the −Z-side surface of the current collector 11 constituting the anode terminal electrode 2A. The cathode terminal electrode 2B has a configuration obtained by removing the anode active material layer 12A from the bipolar electrode 1. An insulating layer 19B covering the peripheral edge of the current collector 11 is formed on the +Z-side surface of the current collector 11 constituting the cathode terminal electrode 2B.

In the present embodiment, metal foil (for example, aluminum foil) is used as the current collector 11 of each electrode. One side or both sides of the metal foil may be subjected to surface treatment (for example, plating). A voltage detection terminal 20 is connected to the current collector 11 of each electrode. In the present embodiment, the voltage detection terminal 20 includes stainless steel (for example, SUS304). Stainless steel has excellent corrosion resistance, heat resistance, and workability. However, the material of the voltage detection terminal 20 may be changed as appropriate. Other metals (for example, copper) may be used instead of stainless steel.

The anode active material layer 12A contains an anode active material. The cathode active material layer 12B contains a cathode active material. In the present embodiment, the cathode active material of each cell included in the stack 10 contains lithium iron phosphate (LiFePO₄) having an olivine structure. The anode active material of each cell contains, for example, a carbon-based material. Other examples of anode active materials include silicon and tin.

In the stack 10, cells C are formed between the stacked current collectors 11. Specifically, a cell C is formed between one current collector 11 (first current collector) and a current collector 11 adjacent to the first current collector (second current collector). A cell C is also formed between the second current collector and another current collector 11 adjacent to the second current collector (third current collector). In this way, the current collectors 11 and the cells C are alternately arranged in the stacking direction of the stack 10. The sealing portion 3 includes sealing layers 14, 15 disposed around each of the cells C included in the stack 10, and also includes the insulating layers 19A, 19B described above. Any sealing material may be used as the material of the sealing portion 3.

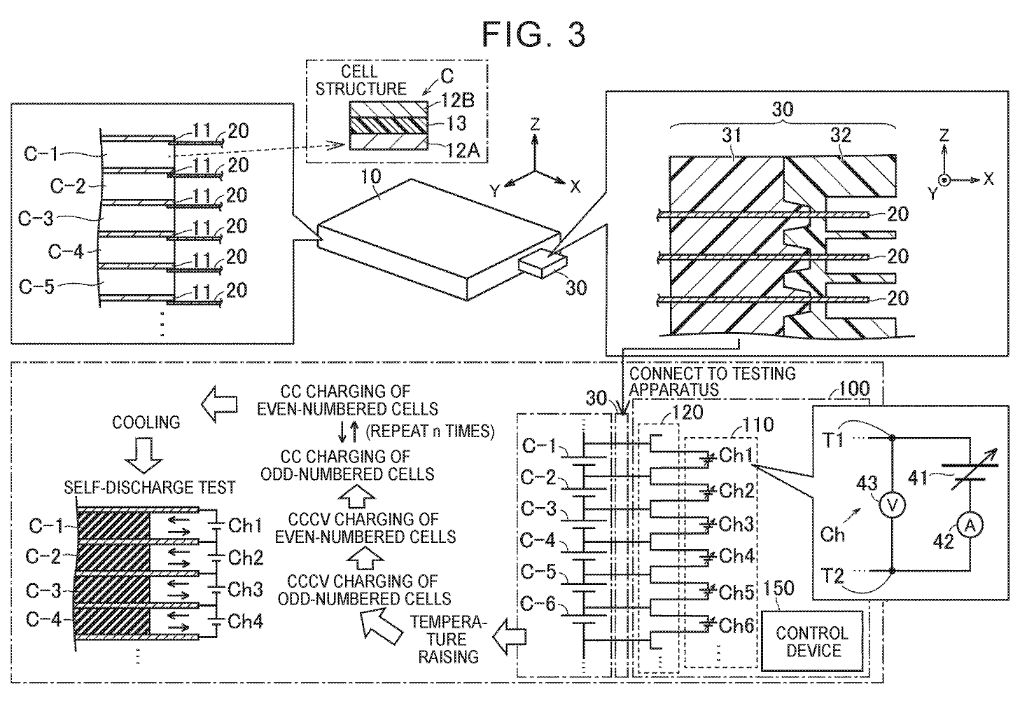

The stack 10 functions as a bipolar secondary battery. Each of the cells C included in the stack 10 (in particular, in the energy storage portion 10a) functions as, for example, an LFP battery (more specifically, a lithium-ion secondary battery containing olivine-type lithium iron phosphate as the cathode active material). Hereinafter, the first cell C, the second cell C, the third cell C, . . . from the end on the cathode side (+Z-side) of the stack 10 may be referred to as cell C-1, cell C-2, cell C-3, . . . , respectively (see FIG. 3 described later). In the stack 10, the cells are stacked in the Z-direction. Adjacent cells share a common electrode. Specifically, the current collector 11 and the voltage detection terminal 20 located between adjacent cells function as a common electrode. This common electrode functions as common wire described later (see FIG. 3).

The manufacturing system of the present embodiment forms the stack 10 (FIG. 2), to which the voltage detection terminals 20 are connected, through various steps such as coating, pressing, seal welding, separator welding, cutting, terminal (voltage detection terminal) welding, end-face welding, and injection port welding. Although not shown in FIG. 2, a connector 30 (see FIG. 3) described later is further provided for the voltage detection terminals 20. The stack 10 may be restrained by a restraining jig. The stack 10 may be clamped and pressed between a pair of end plates (restraining plates).

The manufacturing system of the present embodiment includes: a system that prepares the stack 10 (a system including apparatuses corresponding to the respective steps performed to form the stack 10); and a testing system that performs electrolyte injection, charging, aging, and testing for the stack 10. However, manufacturing of the energy storage device (including testing) may not be fully automated (that is, may not be performed entirely by apparatuses), and a person (operator) may perform part of the processing. The structure of the stack 10 is not limited to that shown in FIG. 2 and may be modified as appropriate.

Referring again to FIG. 1, when the stack 10 obtained as described above (for example, a restrained stack 10) is transferred to the testing system, the testing system automatically executes the process flow shown in FIG. 1 for the stack 10. the flowchart, “S” indicates a step. The letter "S" in the flowchart indicates a step.

In S11, the testing system injects an electrolyte solution into the stack 10. As a result, the space surrounded by the sealing portion 3 in FIG. 2 is filled with the electrolyte solution. The separators 13 are impregnated with the electrolyte solution. The electrolyte solution is, for example, a non-aqueous electrolyte solution. However, the electrolyte solution is not limited to this, and may be an aqueous electrolyte solution. A gel or solid electrolyte may also be used instead of the electrolyte solution.

Thereafter, in S12, the testing system performs initial charging of the stack 10. Initial charging is the first charging of the formed stack 10. For example, the testing system applies a voltage between the cathode terminal and the anode terminal of the stack 10 (for example, between the current collectors 11 located at both ends in the Z-direction shown in FIG. 2). As a result, all the cells C connected in series are charged.

Subsequently, in S13, the testing system performs a temperature-raising process that raises the temperature of the stack 10 to an aging temperature higher than room temperature. For example, the testing system may place the stack 10 in a temperature-controlled chamber and adjust the temperature of the stack 10 using the chamber. The aging temperature may be 50° C. or higher and 75° C. or lower. However, the aging temperature is not limited to this range, and may be lower than 50° C. or higher than 75° C. In the present embodiment, the aging temperature is set to 65° C.

Subsequently, in S14, the testing system performs CCCV charging on odd-numbered cells during high-temperature aging of the stack 10. "Odd-numbered cells" are a group of cells C at odd-numbered positions counted from one end of the stack 10 (for example, the end on the cathode side) (cells C-1, C-3, . . .). CCCV charging refers to charging in which constant-current (CC) charging is performed with a constant charging current, and when the voltage reaches a set value, the charging is switched to constant-voltage (CV) charging. CV charging corresponds to "constant-voltage charging" in the present disclosure.

More specifically, the testing system maintains the temperature of the stack 10 at the aging temperature until a predetermined time (hereinafter referred to as "aging time") elapses. The aging time may be five hours or more and 20 hours or less. However, the aging time is not limited to this range, and may be shorter than five hours or longer than 20 hours. In the present embodiment, the aging time is set to 10 hours.

Individual charging of the odd-numbered cells included in the stack 10 is performed at the aging temperature. The testing system performs CC charging on each odd-numbered cell until the voltage reaches a set value, and then performs CV charging on those cells whose voltage have reached the set value. For example, the testing system switches to CV charging when the voltage reaches 3.7 V or higher during CC charging. In the present embodiment, the voltage applied to each cell during individual charging of the odd-numbered cells (hereinafter referred to as the "charging voltage") is set to the upper-limit voltage of the cell C (the LFP battery described above). The upper-limit voltage of the cell C corresponds to the voltage of the cell C in a fully charged state. In the present embodiment, the upper-limit voltage of the cell C is 3.7 V or more to 3.8 V or less. The testing system continues CV charging of the odd-numbered cells until a predetermined time (hereinafter referred to as the "charging time") elapses.

Subsequently, in S15, the testing system performs CCCV charging on even-numbered cells during high-temperature aging of the stack 10. "Even-numbered cells" are a group of cells C at even-numbered positions counted from the end on the cathode side of the stack 10 (cells C-2, C-4, . . .). CCCV charging is performed on the even-numbered cells in the same manner as the individual charging of the odd-numbered cells described above. Therefore, detailed description thereof will not be repeated. The testing system performs CC charging on the even-numbered cells and switches to CV charging for those cells whose voltage has reached the set value. The testing system continues the CV charging until the charging time elapses.

Subsequently, in S16, the testing system performs CC charging on the odd-numbered cells during high-temperature aging of the stack 10. For example, the testing system performs CC charging until the voltage of each odd-numbered cell exceeds a threshold (for example, 3.7 V). Alternatively, the testing system may perform CC charging on the odd-numbered cells (hereinafter "CC charging on the odd-numbered cells" will be referred to as "CC charging A") until an elapsed time exceeds a threshold, or may perform CC charging until the elapsed time exceeds a threshold and the voltage exceeds a threshold. For example, the thresholds for elapsed time and voltage may be determined in advance by experiments, simulations, or the like such that, at the start of the subsequent self-discharge test, the odd-numbered cells and the even-numbered cells have substantially the same voltage and dV/dt (for example, such that the difference between the maximum and minimum values is less than or equal to a threshold), and may be stored in a storage device of a control device 150.

Subsequently, in S17, the testing system performs CC charging on the even-numbered cells during high-temperature aging of the stack 10. The CC charging for the even-numbered cells (hereinafter referred to as "CC charging B") is the same as CC charging A described above, except that the charging target is different. Therefore, detailed description thereof will not be repeated.

Subsequently, in S18, the testing system determines whether CC charging A and CC charging B have been performed n times. For example, when S16 and S17 are executed, the testing system increments a counter by one. When the value of the counter is greater than or equal to a threshold n, the testing system determines that CC charging A and CC charging B have been repeated n times. The threshold n is the number of repetitions set such that, by repeating CC charging A and CC charging B, the voltage of the odd-numbered cells and the voltage of the even-numbered cells become substantially equal after completion of the CC charging, and is determined in advance by experiments, simulations, or the like. When it is determined that CC charging A and CC charging B have been repeated n times (YES in S18), the process proceeds to S19. When it is determined that CC charging A and CC charging B have not been repeated n times (NO in S18), the process returns to S16.

In the present embodiment, the testing system continues high-temperature aging until CCCV charging of the odd-numbered cells, CCCV charging of the even-numbered cells, and repetition of CC charging A and CC charging B are completed, and ends the high-temperature aging when repetition of CC charging A and CC charging B is completed. However, the present disclosure is not limited to this. For example, high-temperature aging may be ended before CCCV charging of the odd-numbered cells is started, and high-temperature aging may be performed on the stack 10 while the stack 10 is in a non-charging state after repetition of CC charging A and CC charging B is completed.

Subsequently, in S19, the testing system cools the stack 10 to a predetermined temperature (hereinafter referred to as "test temperature"). The test temperature may be 20° C. or higher and 40° C. or lower. The test temperature may be room temperature. In the present embodiment, the test temperature is set to 25° C.

Subsequently, in S20, the testing system performs a self-discharge test on each cell included in the stack 10.

The processing of S13 to S20 will be described with further reference to FIG. 3. FIG. 3 is a diagram illustrating charging of each cell and a self-discharge test performed after charging. Prior to S13, the testing system connects the voltage detection terminals 20 of the respective cells to a power supply, as shown in FIG. 3.

More specifically, the connector 30 is provided for the voltage detection terminals 20 connected to the stack 10 (see FIG. 2). The voltage detection terminals 20 are, for example, welded to the +X-side ends of the current collectors 11. Examples of the welding method include ultrasonic welding and laser welding. The connector 30 includes a resin portion 31 and a housing 32. For example, the housing 32 that aligns the voltage detection terminals 20 is attached to the distal ends of the voltage detection terminals 20. In this state, the resin portion 31 connecting the +X-side end face of the stack 10 and the housing 32 is formed by injection molding. The connector 30 connected to the stack 10 is thus formed. The voltage detection terminals 20 are configured to be connectable to an external power supply (for example, a direct current power supply 41). Each of the voltage detection terminals 20 functions as a pin of the connector 30. The connector 30 is a male connector and is configured to mate with a female connector (for example, a socket).

The testing system in the present embodiment includes a testing apparatus 100. The testing apparatus 100 includes a power supply unit 110, a connection unit 120, and the control device 150. The control device 150 includes a processor and a storage device. In the present embodiment, a self-discharge test is performed by the processor executing a program stored in the storage device. However, the processing related to the self-discharge test may alternatively be executed by hardware (electronic circuits) without using software.

The power supply unit 110 includes a plurality of channels (hereinafter also referred to as "Ch") for the self-discharge test. Each channel (Ch) includes a direct current power supply 41, an ammeter 42, a voltmeter 43, and terminals T1, T2. The output voltage of the direct current power supply 41 is variable. The direct current power supply 41 is controlled by the control device 150. The ammeter 42 is connected in series with the direct current power supply 41, and the voltmeter 43 is connected in parallel with the direct current power supply 41. The ammeter 42 detects a current flowing through a cell connected to the channel (Ch). The voltmeter 43 detects voltage between the terminals T1, T2.

The connection unit 120 functions as a female connector configured to mate with the connector 30. When the connection unit 120 of the testing apparatus 100 is connected to the connector 30, the voltage detection terminals 20 of the respective cells are connected to the power supply (direct current power supply 41). The testing apparatus 100 may include a robot that connects connectors. When each terminal of the connector 30 (for example, a male terminal) is connected to a corresponding terminal of the connection unit 120 (for example, a female terminal), each cell included in the stack 10 is connected to the power supply unit 110 of the testing apparatus 100. As a result, a test circuit is formed for each cell. Test circuits of adjacent cells C (energy storage cells) share a common wire portion. Each test circuit is a closed circuit including a cell C, a channel (Ch), and a common wire. In FIG. 3, Ch1, Ch2, Ch3, Ch4, Ch5, and Ch6 are channels connected to cells C-1, C-2, C-3, C-4, C-5, and C-6, respectively.

In the process flow shown in FIG. 1, when temperature raising of the stack 10 is completed (S13), each of the power supplies (direct current power supplies 41) connected to the odd-numbered cells then applies a voltage to a corresponding odd-numbered cell through a corresponding voltage detection terminal 20 in S14. As a result, power is supplied to each odd-numbered cell from the corresponding power supply (direct current power supply 41) through the corresponding voltage detection terminal 20. By using the voltage detection terminals 20 corresponding to the odd-numbered cells, power (current) can be individually supplied to the odd-numbered cells. As described above, the testing apparatus 100 performs CCCV charging on each odd-numbered cell during high-temperature aging. Through such charging, each odd-numbered cell included in the stack 10 is brought into a fully charged state. By individually charging each odd-numbered cell, the state of charge (SOC) of each odd-numbered cell can be more easily brought close to 100%. The SOC represents the ratio of a current amount of charge to the amount of charge in a fully charged state. At this time, the even-numbered cells are not being charged.

Subsequently, in S15, each of the power supplies (direct current power supplies 41) connected to the even-numbered cells applies a voltage to a corresponding even-numbered cell through a corresponding voltage detection terminal 20. As a result, power is supplied to each even-numbered cell from the corresponding power supply (direct current power supply 41) through the corresponding voltage detection terminal 20. By using the voltage detection terminals 20 corresponding to the even-numbered cells, power (current) can be individually supplied to the even-numbered cells. As described above, the testing apparatus 100 performs CCCV charging on each even-numbered cell during high-temperature aging. Through such charging, each even-numbered cell included in the stack 10 is brought into a fully charged state. By individually charging each even-numbered cell, the SOC of each odd-numbered cell can be more easily brought close to 100%. At this time, the odd-numbered cells are not being charged.

Subsequently, in S16, each of the power supplies (direct current power supplies 41) connected to the odd-numbered cells applies a voltage to a corresponding odd-numbered cell through a corresponding voltage detection terminal 20. As described above, the testing apparatus 100 performs CC charging A during high-temperature aging. At this time, the even-numbered cells are not being charged.

Subsequently, in S17, each of the power supplies (direct current power supplies 41) connected to the even-numbered cells applies a voltage to a corresponding even-numbered cell through a corresponding voltage detection terminal 20. As described above, the testing apparatus 100 performs CC charging B during high-temperature aging. At this time, the odd-numbered cells are not being charged.

When CC charging A and CC charging B have been repeated n times (YES in S18), the stack 10 is cooled in S19. Thereafter, when cooling of the stack 10 (S19) is completed, the testing apparatus 100 performs a self-discharge test on each cell included in the stack 10 (S20). Specifically, for a cell under test, the power supply (direct current power supply 41) connected to that cell applies a voltage to the cell through the corresponding voltage detection terminal 20. In the present embodiment, the direct current power supply 41 applies, to the cell, a power supply voltage having the same magnitude as, but an opposite polarity to, the cell voltage at the start of the test. The control device 150 determines whether the current of the cell under test has converged, and for each cell determined to have a converged current, estimates the converged current value as a self-discharge current. The control device 150 may determine that the current has converged when the amount of change in current per unit time becomes less than or equal to a predetermined value. However, the convergence determination method is not limited to this, and any desired method may be used. When the self-discharge test is completed for all cells, the process flow shown in FIG. 1 ends.

Based on the estimated self-discharge current of each cell, the control device 150 determines whether the cell is good or defective. For example, the control device 150 determines a cell to be a short-circuited cell (defective) when the magnitude of the difference in self-discharge current between the cell and a good cell, measured after a predetermined time has elapsed since the start of the test, is greater than or equal to a threshold. The self-discharge current of a good cell may be determined in advance, for example, by experiments or simulations, and stored in the storage device of the control device 150. The control device 150 may determine that the stack 10 is defective when the stack 10 includes at least one short-circuited cell. The testing system may end the process flow shown in FIG. 1 for the stack 10 when at least one cell included in the stack 10 is determined to be defective, and may start the process flow shown in FIG. 1 for the next test target (secondary battery). In this manner, by ending the test once the determination as to whether a given secondary battery is acceptable or defective is completed, and proceeding to testing of the next secondary battery, testing efficiency can be improved.

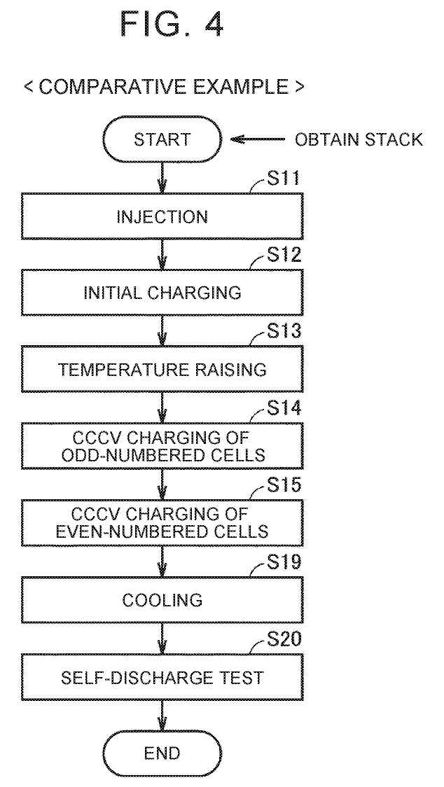

Next, the functions and effects of the method for manufacturing a secondary battery according to the present embodiment (the method according to the embodiment) will be described in comparison with a method according to a comparative example. FIG. 4 is a flowchart showing an example of a method for manufacturing a secondary battery according to the comparative example. In the method according to the embodiment, testing is performed using the process flow described above with reference to FIG. 1. In contrast, in the method according to the comparative example, testing is performed using the process flow shown in FIG. 4. The process shown in FIG. 4 differs from the process shown in FIG. 1 in that steps S16, S17, and S18 are omitted. The other steps are the same as those shown in FIG. 1. Therefore, detailed description of those steps will not be repeated.

In both the method according to the embodiment and the method according to the comparative example, after CCCV charging of the even-numbered cells is completed, the cell voltage of the odd-numbered cells that were subjected to CCCV charging earlier decreases. In the process shown in FIG. 1, however, CC charging A and CC charging B are subsequently repeated n times, and after the n repetitions, the voltage of the odd-numbered cells and the voltage of the even-numbered cells become approximately equal.

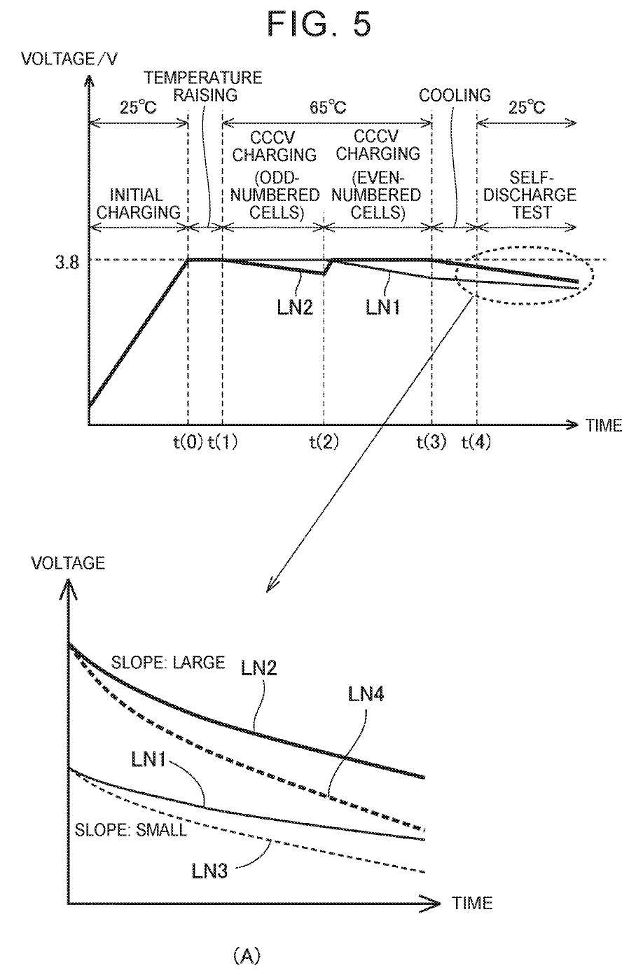

FIG. 5 is a diagram showing an example of voltage changes of odd-numbered cells and even-numbered cells in the comparative example. In FIG. 5, the vertical axis represents voltage, and the horizontal axis represents time. In FIG. 5, LN1 indicates how the voltage of one of the odd-numbered cells changes over time, and LN2 indicates how the voltage of one of the even-numbered cells changes over time. It is herein assumed that the process flow according to the comparative example shown in FIG. 4 is performed.

After electrolyte injection into the stack 10 (S11), initial charging is performed (S12), whereby the voltage of each cell increases as shown by LN1 and LN2 in FIG. 5. Then, a temperature-raising process is performed during the period from time t(0) to time t(1) (S13). When the temperature reaches the aging temperature, CCCV charging of the odd-numbered cells is performed at time t(1) (S14). As shown by LN1 in FIG. 5, when CCCV charging of the odd-numbered cells is performed, CC charging is followed by CV charging, and therefore the voltage of each odd-numbered cell is maintained at a substantially constant level while charging proceeds. On the other hand, since the even-numbered cells are not being charged, their voltage decreases over time after time t(1), as shown by LN2 in FIG. 5.

At time t(2), when the charging time has elapsed, the odd-numbered cells are no longer charged, and CCCV charging of the even-numbered cells is performed (S15). As shown by LN2 in FIG. 5, when CCCV charging of the even-numbered cells is performed, CC charging is followed by CV charging, and therefore the voltage of each even-numbered cell rises to 3.8 V and is then maintained at a substantially constant level while charging proceeds. On the other hand, since the odd-numbered cells are not being charged, their voltage decreases over time after time t(2), as shown by LN1 in FIG. 5.

At time t(3), when the charging time has elapsed, both the odd-numbered cells and the even-numbered cells are no longer charged. After time t(3), the voltages of both the odd-numbered cells and the even-numbered cells decrease as time elapses. At time t(3), cooling of the stack 10 is started (S19), and at time t(4), a self-discharge test is performed on each cell (S20).

(A) of FIG. 5 is an enlarged view showing voltage changes within the dashed frame. In (A) of FIG. 5, the vertical axis represents voltage, and the horizontal axis represents time. In (A) of FIG. 5, LN3 indicates how the voltage of a defective cell among the odd-numbered cells changes over time, and LN4 indicates how the voltage of a defective cell among the even-numbered cells changes over time.

As shown by LN1 in (A) of FIG. 5, since the voltage of the odd-numbered cells is lower than that of the even-numbered cells at the start of the self-discharge test, the slope of the voltage change (dV/dt) of the odd-numbered cells after the start of the self-discharge test is smaller than the slope of the voltage change of the even-numbered cells shown by LN2 in (A) of FIG. 5. Therefore, when identifying defective cells, the magnitude of the voltage difference used to distinguish between acceptable cells and defective cells (defective cells resulting from a short circuit) among the odd-numbered cells, as shown by LN1 and LN3 in (A) of FIG. 5, is smaller than the voltage difference used to distinguish between acceptable cells and defective cells among the even-numbered cells, as shown by LN2 and LN4 in (A) of FIG. 5. As a result, the determination accuracy for distinguishing acceptable cells from defective cells among the odd-numbered cells is lower than the determination accuracy for the even-numbered cells.

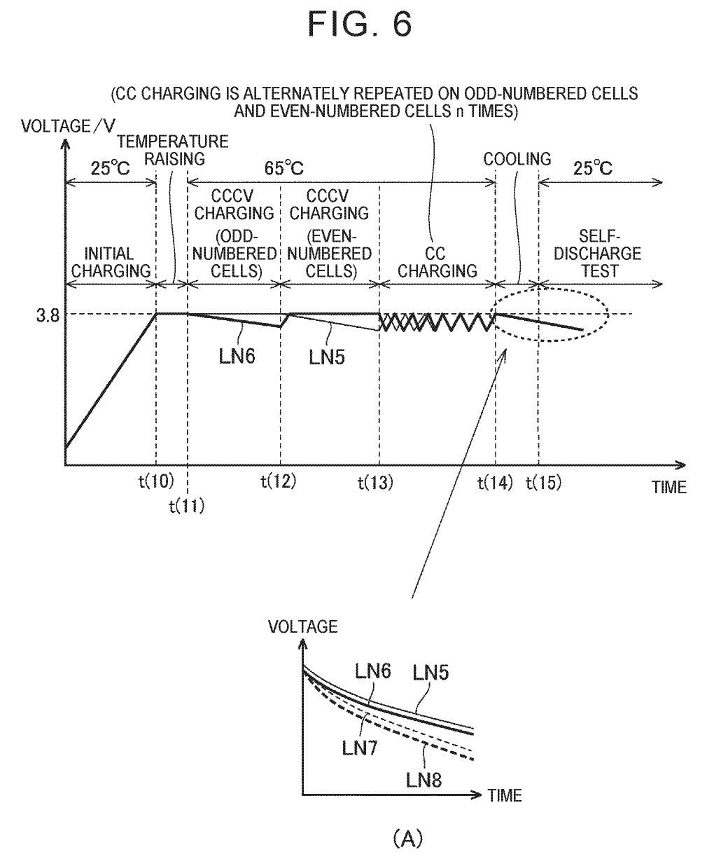

FIG. 6 is a diagram showing an example of voltage changes of odd-numbered cells and even-numbered cells in the present embodiment. In FIG. 6, the vertical axis represents voltage, and the horizontal axis represents time. In FIG. 6, LN5 indicates how the voltage of one of the odd-numbered cells changes over time, and LN6 indicates how the voltage of one of the even-numbered cells changes over time. It is herein assumed that the process flow according to the present embodiment shown in FIG. 1 is performed.

After electrolyte injection into the stack 10 (S11), initial charging is performed (S12), whereby the voltage of each cell increases as shown by LN5 and LN6 in FIG. 6. Then, a temperature-raising process is performed during the period from time t(10) to time t(11) (S13). When the temperature reaches the aging temperature, CCCV charging of the odd-numbered cells is performed at time t(11) (S14). As shown by LN5 in FIG. 6, when CCCV charging of the odd-numbered cells is performed, CC charging is followed by CV charging, and therefore the voltage of each odd-numbered cell is maintained at a substantially constant level while charging proceeds. On the other hand, since the even-numbered cells are not being charged, their voltages decrease over time after time t(11), as shown by LN6 in FIG. 6.

At time t(12), when the charging time has elapsed, the odd-numbered cells are no longer charged, and CCCV charging of the even-numbered cells is performed (S15). As shown by LN6 in FIG. 6, when CCCV charging of the even-numbered cells is performed, CC charging is followed by CV charging, and therefore the voltage of each even-numbered cell rises to 3.8 V and is then maintained at a substantially constant level while charging proceeds. On the other hand, since the odd-numbered cells are not being charged, their voltage decreases over time after time t(12), as shown by LN5 in FIG. 6.

At time t(13), when the charging time has elapsed, CC charging A is performed (S16). When CC charging A is performed, the voltage of the odd-numbered cells increases. When the voltage of the odd-numbered cells reaches a threshold (3.7 V), CC charging A ends and CC charging B is performed (S17). Since CC charging A ends, the voltage of the odd-numbered cells decreases. Since CC charging B is performed, the voltage of the even-numbered cells increases. When the voltage of the even-numbered cells reaches the threshold, CC charging B ends. When CC charging A and CC charging B are alternately repeated n times by time t(14) (YES in S18), the voltage of the odd-numbered cells becomes approximately equal to the voltage of the even-numbered cells when CC charging B ends at time t(14). At time t(14), cooling of the stack 10 is started (S19), and at time t(15), a self-discharge test is performed on each cell (S20).

(A) of FIG. 6 shows voltage changes of the odd-numbered cells and the even-numbered cells after the start of the self-discharge test at time t(15). In (A) of FIG. 6, the vertical axis represents voltage, and the horizontal axis represents time. In (A) of FIG. 6, LN7 indicates how the voltage of a defective cell among the odd-numbered cells changes over time, and LN8 indicates how the voltage of a defective cell among the even-numbered cells changes over time.

As shown by LN7 in (A) of FIG. 6, since the voltage of the odd-numbered cells is substantially equal to the voltage of the even-numbered cells at the start of the self-discharge test, the slope of the voltage change (dV/dt) after the start of the self-discharge test is approximately equal to the slope of the voltage change of the even-numbered cells shown by LN8 in (A) of FIG. 6. Therefore, when identifying defective cells, the magnitude of the voltage difference used to distinguish between acceptable cells and defective cells among the odd-numbered cells, as shown by LN5 and LN7 in (A) of FIG. 6, is approximately the same as the voltage difference used to distinguish between acceptable cells and defective cells among the even-numbered cells, as shown by LN6 and LN8 in (A) of FIG. 6. As a result, the determination accuracy for distinguishing acceptable cells from defective cells among the odd-numbered cells can be improved compared to the comparative example.

As described above, in the method for manufacturing a secondary battery according to the present embodiment, after CCCV charging is performed, CC charging A and CC charging B are alternately repeated for the odd-numbered cells and the even-numbered cells such that the voltages of the odd-numbered cells and the even-numbered cells become equal at the start of cooling. As a result, a self-discharge test can be performed at a high voltage for both the odd-numbered cells and the even-numbered cells. Therefore, it is possible to improve the accuracy of determination as to whether cells are acceptable or defective (short-circuit determination) while also reducing the lead time for the determination. Accordingly, the present disclosure can provide a method for manufacturing a secondary battery that improves the accuracy of short-circuit determination.

Furthermore, by appropriately setting the number of repetitions (n), the execution time of CC charging A and CC charging B, or the voltage threshold for ending CC charging A or CC charging B, the voltages of the odd-numbered cells and the even-numbered cells can be made equal before determination as to whether the cells are acceptable or defective is performed. Therefore, the accuracy of determination as to whether the cells are acceptable or defective can be improved.

The present embodiment illustrates an example in which CCCV charging is performed on the odd-numbered cells, CCCV charging is then performed on the even-numbered cells, and thereafter CC charging A and CC charging B are repeated. However, for example, CCCV charging may be performed on the even-numbered cells first, CCCV charging may then be performed on the odd-numbered cells, and thereafter CC charging B and CC charging A may be repeated.

The present embodiment illustrates an example in which CCCV charging is performed on the odd-numbered cells, CCCV charging is then performed on the even-numbered cells, and thereafter CC charging A and CC charging B are repeated n times. However, for example, CC charging A and CC charging B may be repeated until a predetermined time has elapsed since completion of CCCV charging.

The embodiment disclosed herein should be considered to be illustrative in all respects and not restrictive. The scope of the present disclosure is set forth in the claims rather than in the above description, and is intended to include all modifications within the meaning and scope equivalent to the claims.

What is claimed is:

1. A method for manufacturing a secondary battery including a plurality of cells each including a bipolar electrode and a separator, the cells including a group of odd-numbered cells arranged at odd-numbered positions from one end, and a group of even-numbered cells arranged at even-numbered positions from the one end, the method comprising:
performing constant-voltage charging while alternately switching a charging target between the group of odd-numbered cells and the group of even-numbered cells before determining whether the cells are acceptable or defective; and
after the constant-voltage charging, alternately repeating constant-current charging of the group of odd-numbered cells and constant-current charging of the group of even-numbered cells a plurality of times.

2. The method according to claim 1, further comprising repeatedly performing the constant-current charging a number of times such that a difference between a voltage of one of the group of odd-numbered cells and the group of even-numbered cells after the constant-current charging and a voltage of the other of the group of odd-numbered cells and the group of even-numbered cells before the constant-current charging is less than or equal to a threshold.

3. The method according to claim 1, further comprising alternately repeating the constant-current charging of the group of odd-numbered cells and the constant-current charging of the group of even-numbered cells a plurality of times until a predetermined time has elapsed since completion of the constant-voltage charging.
